(19) United States
(12) Patent Application Publication
(10) Pub. No.: US 2026/0267339 A1
(43) Pub. Date: Sep. 10, 2026

(54) Method and Assistance System for Supporting Vehicle Guidance on the Basis of a Travel Envelope and a Boundary Estimation and Motor Vehicle

(71) Applicant: Bayerische Motoren Werke Aktiengesellschaft, Muenchen (DE)

(72) Inventors: Jens KLAPPSTEIN, Muenchen (DE); Steffen KOERNER, Muenchen (DE); Luca TRENTINAGLIA, Eichenau (DE)

(21) Appl. No.: 18/876,544

(22) PCT Filed: Jun. 16, 2023
(86) PCT No.: PCT/EP2023/066265

§ 371 Date: Dec. 18, 2024

(30) Foreign Application Priority Data
Jun. 21, 2022 (DE) 10 2022 115 447.5

(51) Int. Cl. G05D 1/617; G05D 1/243

(52) U.S. Cl. CPC G05D 1/617; G05D 1/243

(57) ABSTRACT

Please substitute the new Abstract submitted herewith for the original Abstract:

A method for supporting a longitudinal and transverse guiding of a motor vehicle on a road. Environmental data that characterize the environment in the travel direction is detected. A path of a boundary that delimits a passable region of the road in the respective environment and a travel envelope predicted to be travelled by the motor vehicle are estimated based on the environmental data. At least one distance along the travel envelope provided transversely relative to the travel direction of the travel envelope from the estimated path of the boundary is determined. A data set is produced and provided from the travel envelope and the determined distance. The data set indicates the travel envelope and, as a result of the distance, the region which can be travelled along the travel envelope.

### BACKGROUND AND SUMMARY

The present invention relates to a method and an assistance system for supporting a longitudinal and transverse guiding of a motor vehicle. The invention further relates to a correspondingly configured motor vehicle.

For a large number of current and future assistance functions in motor vehicles, it may be advantageous to determine which path is predicted to be travelled by the respective vehicle. This can be described as the so-called travel envelope or travel corridor of the motor vehicle. Such a travel envelope may, for example, be used to identify objects located therein in the respective environment. Such objects can then, for example, be used as target objects for control of adaptive cruise control or other assistance functions and highly or fully automated travel functions.

A method for producing a travel corridor for a vehicle along a carriageway is described, for example, in DE 10 2018 129 079A1. A first corridor seeding without taking into account all of the other vehicles on the carriageway is initially produced therein. For one side of the carriageway based on identified objects a first desired boundary for the corridor is then produced. Furthermore, a desired secondary boundary is produced at an opposing second side of the carriageway. Based on these boundaries, the first corridor seeding is adapted, whereby the travel corridor for the vehicle is produced.

A method for object detection is, for example, described in DE 10 2009 009 047 A1. A distance image is established therein by means of a sensor system and a depth map of an environment is determined therefrom. In the distance image, a free space boundary line which surrounds an obstacle-free region is identified. Outside and along the free space boundary line, the depth map is segmented by segments of the same width being formed from pixels with the same or similar distance with respect to a plane. In this instance, a height of each segment is estimated as part of an object located outside the obstacle-free region so that each segment is characterized by a two-dimensional position of a base point and the height thereof.

In principle, a robust and precise identification and representation of the respective environment, for example, for the corresponding prediction of the travel envelope or a trajectory planning, for instance, for an emergency maneuver may be advantageous. However, this still until now constitutes a significant challenge. For example, map data which are often used for this purpose often have the problem that they are not up to date, that is to say, do not adapt rapidly enough to dynamic environmental changes, such as roadworks or closures or the like. The segmenting of camera images of the environment as often used is also not always reliable and may, for example, be influenced by environmental influences, such as heavy rain, dazzling sunlight, snow or the like. It is additionally problematic that in motor vehicles for the prediction of the travel envelope and/or assistance functions which are based thereon control devices or embedded systems with highly limited processing power are often used but the corresponding data and information items have to be processed and interpreted in real time or as rapidly as possible during operation of the motor vehicle.

An example of a method for producing an environmental model of a vehicle is described in DE 10 2014 212 487 A1. Herein, based on objects and/or free space boundaries and/or carriageway boundaries, a lane which indicates the region around the vehicle which can be freely travelled is established. The lane comprises at least one lane segment which in turn comprises at least one lane segment boundary. With respect to this, the vehicle-related distance is determined. Furthermore, the lane is made available to a driver assistance system. As a result of such a method for producing an environmental model, the complexity for producing new driver assistance systems can be reduced and a simpler integration of new sensor systems can be enabled.

An object of the present invention is to enable a particularly robust, efficient and effective assisted or at least partially automated vehicle guiding.

This object is achieved according to the invention by the aspects of subject-matter of the independent patent claims. Possible embodiments and further developments of the present invention are disclosed in the dependent patent claims, the description and in the Figures.

The method according to the invention can be used in order to enable a support of a longitudinal and transverse guiding of a motor vehicle on or along a road. In one method step of the method according to the invention, environmental data which map or characterize a respective environment which is in particular located in front in the travel direction of the motor vehicle are detected. The detection of these environmental data may in this instance mean or involve the recording thereof by means of an environmental sensor system, in particular by means of a plurality of different environmental sensors, receiving the environmental data via a data connection or interface and/or retrieving the environmental data from a data store.

In another method step of the method according to the invention, at least based on the detected environmental data, a path of at least one boundary or a corresponding boundary feature, whereby a region of the road which can be travelled is limited in the respective environment, and a travel envelope which the motor vehicle is predicted to travel, is predicted, that is to say, estimated. The travel envelope extends in this instance from the respective current position of the motor vehicle in the travel direction thereof away from the motor vehicle along the road or through the respective environment. In order to estimate the path of the boundary, for example, a crash barrier, a grass verge, a carriageway or road lane marking and/or the like may be detected or identified in the detected environmental data. The path of the boundary can thus, at least with the exception of the uncertainties which are inevitably contained therein, be derived directly from the environmental data. In order to ultimately estimate the boundary path and/or the travel envelope, a corresponding predetermined estimation model can be used. This may, for example, be an algorithmic model, a simulation model, a model which is on the basis of machine learning, that is to say, an artificial, neuronal network, or the like. In order to estimate the boundary path and/or the travel envelope, in addition to the environmental data additional data can also be detected and used, such as, for example, current, directly preceding and/or historical data relating to an operation or state of the motor vehicle, such as the steering angle thereof, steering angle rates of change, yaw rate and/or the like, map data, navigation data, movement data of other road users in the respective environment and/or the like. This can ultimately enable a particularly precise, robust and reliable estimation of the path of the boundary and/or the travel envelope.

In another method step of the method according to the invention, along the estimated travel envelope at least one distance which is provided transversely to the travel direction of the motor vehicle, that is to say, transversely relative to the longitudinal extent of the travel envelope, from the travel envelope to the estimated path of the boundary is determined. This distance may, for example, be determined at several or all locations of the travel envelope. The distance may in particular be determined at both sides or in both directions, that is to say, in the travel direction along the travel envelope when viewed to the left and to the right. Depending on the boundaries identified or estimated, distances with respect to several different boundaries can also be determined in this instance.

In another method step of the method according to the invention, a combined or integrated data set is produced and provided from the estimated path of the travel envelope and the at least one determined distance, that is to say, the determined distances or distance values. In this instance, there is also taken into account the location at which, that is to say, at which spatial position, the respective distance is provided. In the data set produced and provided in this manner, the estimated travel envelope and in addition at least as a result of the at least one distance, that is to say, at least implicitly or also explicitly, the region which can be travelled by the motor vehicle along the travel envelope are indicated.

The travel envelope estimation is thus expanded in this instance by the region which can be travelled. As a result of the combination or integration in the data set, in which the distance and the travel envelope may be indicated or contained in a state directly linked to each other, a particularly efficient encoding and availability of these data can be enabled, for example, in comparison with two separate data sets for the travel envelope and the region which can be travelled or a subsequent establishment of the travel envelope from a data set in which initially only the region which can be travelled is indicated, or vice versa. The data set which is proposed in this instance, that is to say, the combination of travel envelope estimation and boundary estimation, may represent a particularly compact representation of the corresponding data or the respective environment. Consequently, it may be possible in a particularly simple manner for subsequent algorithms or assistance functions or assistance systems to take these data from the data set and process them. Consequently, corresponding assistance functions can be carried out or applied in a particularly efficient and non-complex manner, that is to say, also in an effective manner with correspondingly limited hardware or processing resources, in particular in real time, during operation of the respective motor vehicle.

The representation of the region which can be travelled as proposed in this instance by the distance from the inner edge thereof of the travel envelope is, for example, in comparison with complete pixel-segmented 3D environment models or the like, particularly efficient since, in addition to the travel envelope required in any case for many assistance functions, only a particularly small amount of data have to be stored. Therefore, for example, embedded systems which typically have relatively little processing power and a relatively small data store can then also be used. Another advantage of the present invention is that, as a result of the representation or description of the region which can be travelled from the perspective of the travel envelope, that is to say, with respect to the travel envelope, only the region which can be travelled and which is in each case actually relevant for the longitudinal and transverse guiding of the motor vehicle is automatically indicated or stored. It is thus, for example, possible for other surfaces which can in principle be travelled on but which, as a result of the -where applicable not passable-boundary, are separated from the travel envelope and consequently not relevant for the motor vehicle, remain unconsidered. It is thereby possible, for example for the search area for a trajectory planning, be it along the travel envelope or for maneuvers leaving the travel envelope, to be accordingly restricted or limited. It is thereby possible for a corresponding trajectory planning to then also be carried out in a particularly efficient, effective and non-complex manner.

The travel envelope may also be indicated, for example, as a traverse which in addition to spatial x and y coordinates also contains additional information items or data, such as, for example, the orientation or direction and the width of the travel envelope perpendicular thereto. For each location or portion of the travel envelope or the traverse, the distance or the distances with respect to the at least one boundary at that location can then be stored in the data set. The path of the respective boundary, for example, as an additional traverse, can also be indicated or stored in the data set. Consequently, from the data set or from the traverse which is expanded by the corresponding information items or data for the travel envelope, the region which can be travelled along the travel envelope can be read or extracted.

In order to estimate the travel envelope or the path of the boundary, it is possible to use, for example, the information filter mechanism known per se which uses the information matrix, that is to say, the inverse of the covariance matrix, and the information vector or information state vector which is connected to the estimation vector by the information matrix. Consequently, the estimation of the travel envelope and the path of the boundary can be carried out in one operating step or pass, that is to say, also in a particularly rapid, efficient and non-complex manner.

In one possible embodiment of the present invention, for the estimation of the boundary and the travel envelope, a plurality of various, in particular different, data types are combined with each other, in particular merged. In this instance, in particular data from a plurality of different types of sensors can be combined with each other. Other data types which, for example, do not have to originate from a conventional sensor, can also be used, such as trajectory or swarm movement data, which indicate the movements of other vehicles in the respective environment, map data and/or the like. For example, from the different data types, a plurality of hypotheses for the road path and consequently at least indirectly for the path of the boundary and/or directly for the path of the travel envelope can be produced. These hypotheses can be combined with each other. To this end, the hypotheses may, for example, in particular be weighted, averaged or the like. These hypotheses may be traverses which originate from different sources, that is to say, for example, can be based on different data types or combinations of data types. They may, for example, be road boundaries, road lane markings, histories of other road users, swarm trajectories and/or the like. As a result of the use of a plurality of different data types as proposed in this instance, a more precise, robust and reliable estimation can be achieved. For example, problems or effects which relate to or impair a single sensor or a single data type may not influence other sensors or data types. Consequently, under a large number of different conditions with a particularly high level of probability, there is then always at least one data type available, from which the path of the boundary can be derived or correctly estimated.

In another possible embodiment of the present invention, a distinction is made between hard boundaries which must not be passed and soft boundaries which can be passed. Consequently, the distance, for example, consistently only with respect to hard boundaries or only with respect to soft boundaries can be determined or a first distance from a soft boundary and a second distance from a hard boundary can be determined. These distances can then both be indicated in the data set. Consequently, therefore, the region which can be travelled can then accordingly be or become defined in a graduated state. For example, for error-free and unobstructed normal operation in which the motor vehicle is guided only as far as the next soft boundary in the respective direction, the region which can be travelled can be defined by the distance from this soft boundary. In contrast, for emergency operation, in which passing soft boundaries may be permitted and the motor vehicle, for instance, in order to avoid a collision with another road user, can be guided up to the next hard boundary in the respective direction, the region which can be travelled can be or become defined by the next hard boundary. Consequently, in a particularly simple and efficient manner, a situation-adapted vehicle guiding can be enabled.

In one possible further development of the present invention, only the distances of the travel envelope from the next hard boundaries at both sides of the travel envelope and/or only the distances of the travel envelope from the detectable or estimated soft boundaries which are furthest away from the travel envelope at both sides of the travel envelope are determined and indicated in the data set. The distances indicated in the data set can thus be the distances from hypotheses located furthest apart or furthest from the travel envelope in both transverse directions for the soft boundaries and/or the hypotheses located closest together for the hard boundaries. In other words, therefore, if a plurality of soft boundaries and/or a plurality of hard boundaries are detected at different distances from the travel envelope, the closest ones of a plurality of soft boundaries or the furthest ones of a plurality of hard boundaries may then be discarded. Corresponding data-processing complexity can thus be saved. As a result of the limitation of the boundaries used or taken into account as proposed in this instance, only precisely the entire relevant region which can be travelled in each case can be indicated or defined in a particularly simple and efficient manner. If a plurality of distances with respect to different types of boundaries are indicated in the data set, this can accordingly be indicated or characterized. This may also enable in a particularly simple, efficient and non-complex manner a correspondingly adapted function implementation, for example, a trajectory planning, based on the data set.

In a possible further development of the present invention, road lane or carriageway markings are used as soft boundaries, that is to say, taken into account or accordingly classified. From such soft boundaries, the information can be clearly and safely derived that a corresponding region, that is to say, for example, the region between a pair of such carriageway markings or the region around the respective vehicle trajectory, can actually be travelled. At the same time, such soft boundaries may enable a particularly simple and effective trajectory planning.

In a possible further development of the present invention, structural devices, in particular crash barriers, walls, such as noise barriers or walls or the like, ditches and areas of vegetation, are used as hard boundaries, that is to say, taken into account or accordingly classified. Such hard boundaries may accordingly define peripheral conditions, for instance, for a trajectory planning, in order, for example, to avoid collisions of the motor vehicle with such hard boundaries or to avoid the motor vehicle becoming out of control when attempting to pass such hard boundaries. A specific identification of such hard boundaries can thus improve the safety during the vehicle guiding. At the same time, for example, the search area for the trajectory planning for emergency or evasive maneuvers can also be strictly limited, which may enable a correspondingly more rapid, effective and reliable trajectory planning. For example, consequently, possible space which can be travelled and consequently corresponding safety potential is not dispensed with, which could be the case if the space which can be travelled were to be strictly limited only by soft boundaries. On the other hand, additional data-processing complexity can be saved and a corresponding safety risk can be reduced when a surface located beyond a hard boundary which cannot be travelled over is strictly excluded with respect to the passability or the trajectory planning.

In a possible further development of the present invention, the hard boundaries are further distinguished into physical boundaries, which it is not possible to pass, on the one hand, and rule-based boundaries, which may not be passed only in accordance with predetermined rules, on the other hand. In the data set, as long as and in so far as such hard boundaries are present in the respective environment, separate distances of the travel envelope from physical boundaries and rule-based boundaries are then indicated. Physical boundaries may in the present context thus be physical barriers which make it impossible for the motor vehicle to move beyond them. Such physical boundaries may, for example, be crash barriers, noise barriers, strips of vegetation with correspondingly dense trees or the like. In contrast, the rule-based boundaries may in principle be able to be travelled over from a purely physically technical, that is to say, practical viewpoint, but which is then, for example, at least during normal operation not permissible where applicable. Such rule-based boundaries may, for example, be vegetation strips with exclusively accordingly low or flat vegetation, grass verges, relatively shallow ditches, edging stones or the like. An attempt to travel over the physical boundaries can then under all circumstances be excluded. An attempt to travel over a rule-based boundary may in contrast under specific, predetermined circumstances, for example, in a maximum escalation stage of emergency operation or the like, be permitted or taken into account. Accordingly, the hard boundaries or the corresponding distances can be characterized, marked or classified in the data set. Consequently, therefore, the region which can be travelled over can be indicated or defined in a classified state for correspondingly different situations. It is thus possible, for example, for a region between a rule-based boundary and the next but more remote physical boundary to be classified or indicated for normal operation or also for a lower escalation stage of emergency operation as a non-passable region, but for emergency operation or the maximum escalation stage of emergency operation as a passable region or as a conditionally passable region. A conditionally passable region in this context may, for example, be passable on condition that there is no threat of a collision, for example with a pedestrian or cyclist or with oncoming traffic or the like, and at the same time, such a collision in a region which is also passable in normal operation can be avoided, in particular only avoided, by swerving into the conditionally passable region. During normal operation or also in the lower escalation stage of emergency operation, the search area for the trajectory panning can accordingly be limited, which may contribute to a reduced data-processing complexity and consequently to a particularly rapid and non-complex trajectory planning. At the same time, on the whole an improved safety as a result of situation-adapted use of all possibilities can be achieved.

In order to identify the respective boundaries, that is to say, the nature or type thereof, for example, a corresponding object identification can be used.

In another possible embodiment of the present invention, in a portion along the travel envelope in which no boundary can be detected or estimated, the distance is set to zero. In other words, in such a portion the passable region is thus limited to the corresponding side or limit of the travel envelope. A particularly high level of safety can thereby be achieved during the vehicle guiding since the vehicle guiding then does not have to rely on assumptions or purely speculative extrapolation of the path or a boundary or the like. As a result of the embodiment of the present invention as proposed in this instance, it may thus be possible in a particularly simple and non-complex manner for the vehicle to be guided only in regions which have actually been identified as passable. This is possible in particular without significant additional data-processing or modelling complexity.

Another aspect of the present invention is an assistance system for a motor vehicle. The assistance system according to the invention has an interface for detecting environmental data which characterize an environment which is located in front in each case in the travel direction, a processor device which is coupled thereto, that is to say, for example, a microchip, microcontroller or microprocessor or the like, and a computer-readable data store which is coupled to the processor device. The assistance system according to the invention is in this instance configured in particular to automatically carry out the method according to the invention. To this end, there may be stored in the data store a corresponding operating or computer program which encodes or implements the method steps, procedures or measures or corresponding control instructions which are described in connection with the method according to the invention. This operating or computer program may then be able to be carried out by the process device in order to carry out the corresponding method or to bring about the implementation thereof. The assistance system according to the invention may, for example, be in the form of a control device, in particular as an embedded system.

Another aspect of the present invention is a motor vehicle which has an environmental sensor system for recording environmental data which characterize a respective environment which is located in front in the travel direction, and an assistance system according to the invention. The environmental sensor system may in this instance be part of the assistance system or be coupled thereto, for example, via an on-board network of the motor vehicle. The motor vehicle according to the invention may in particular be the motor vehicle mentioned in connection with the method according to the invention and/or in connection with the assistance system according to the invention or correspond to it.

Other features of the invention may be derived from the claims, the Figures and the description of the Figures. The features and feature combinations mentioned above in the description and the features and feature combinations set out below in the description of the Figures and/or in the Figures alone can be used not only in the combination set out but also in other combinations or alone without departing from the scope of the invention.

### BRIEF DESCRIPTION OF THE DRAWING

The FIGURE shows an exemplary schematic overview in order to illustrate one possibility for supporting vehicle guiding.

### DETAILED DESCRIPTION OF THE DRAWING

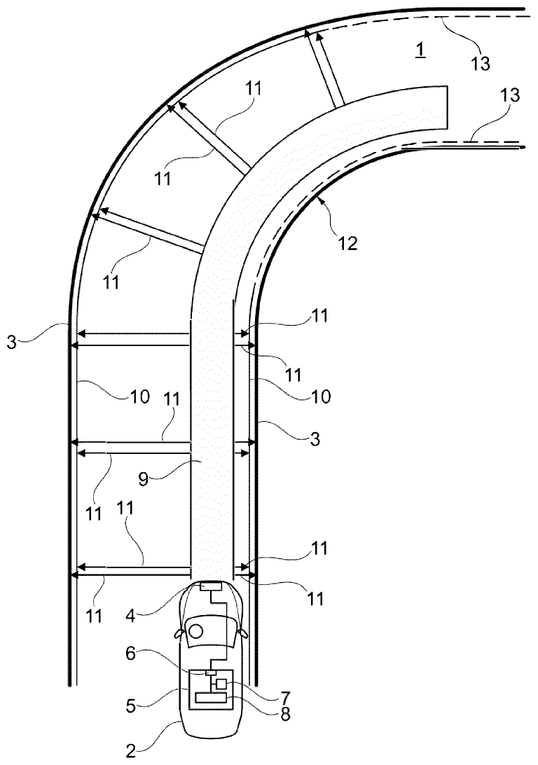

FIG. 1 shows an exemplary schematic overview cut-out to illustrate a method for supporting a longitudinal and transverse guiding of a vehicle. Specifically, a portion of a road 1 which comprises a bend is illustrated here. This may in particular be a graphic representation of a corresponding data set. For illustration, a motor vehicle 2 which moves along the road 1 is illustrated in this instance. In principle, the motor vehicle 2 could move along the entire road 1, that is to say, within the carriageway edges 3. The carriageway edges 3 may thus—in this instance illustrated at the outer side-be non-passable hard boundaries of a passable region or space, such as, for example, crash barriers, noise barriers or the like. In practice, however, there may also be soft boundaries which can be passed, such as, for instance, road lane markings 13 or guidelines for maintaining distance with respect to the carriageway edge 3 and/or the like, whereby a region or space which is—at least outside emergency situations—actually intended to be travelled is delimited. Furthermore, for technical assistance functions or at least partially automated vehicle guiding, a technical identification or determination of the region which can actually be travelled—where applicable classified in accordance with soft and hard boundaries—is necessary or at least advantageous. To this end, the motor vehicle 2 is in this instance provided with an environmental sensor system 4 and an assistance system 5. The environmental sensor system 4 can record environmental data which map or characterize an environment which is in particular located in front in the travel direction of the motor vehicle 2. These environmental data can then be detected by the assistance system 5 via an interface 6 and processed by means of a processor 7 and a data store 8.

The environmental sensor system 4 may in this instance comprise a plurality of different sensors and in addition via the interface 6 additional data which can then also be processed accordingly by the assistance system 5 can be detected. From the detected data, the assistance system 5 can produce a travel envelope estimation 9 and a boundary estimation 10. The travel envelope estimation 9 predicts a travel envelope of the motor vehicle 2 along the road 1. The boundary estimation 10 estimates a path of one or more boundaries which delimit or define a passable region around the travel envelope. In the example illustrated in this instance, the boundary estimation 10 may, for example, be along the carriageway or road lane markings 13. An additional boundary estimation for the path of the carriageway edges 3 can also be carried out. In this instance, a distinction can thus be made between passable soft boundaries and non-passable hard boundaries. A hard boundary may strictly delimit the passable region since passing or exceeding it is not possible. A soft or gentle boundary may, in contrast, for example, be a marking which it is possible or may be possible or permitted to pass or exceed where applicable, that is to say, under specific predetermined conditions.

Along the travel envelope estimation 9, at each point or portion a distance 11 which is given at that location in the local transverse direction with respect to one or more boundary estimations 10 can be determined. In each case, a distance 11 with respect to a soft boundary and a distance with respect to a next, in particular in the respective direction, hard boundary can be determined as long as and in so far as such different boundaries are provided or can be identified or estimated. This is in this instance indicated by way of example for a plurality of locations along the travel envelope estimation 9. In this instance, for the sake of clarity, only some of the distances 11 are depicted here and of these only an exemplary selection are explicitly characterized. The distances 11 may in particular be determined from the travel envelope estimation 9, for example, the edge or center line thereof, from the next hard boundary at the respective side or in the respective direction and/or from the soft boundaries located furthest away from each other or from the travel envelope estimation 9 and which are located closer to the travel envelope estimation 9 than the next hard boundary. By way of example, an undefined portion 12 in which at least at one side of the travel envelope estimation 9 no boundary estimation 10 could be produced is also indicated here. In the undefined portion 12, the distance 11 in the corresponding direction can therefore be set to zero.

The travel envelope estimation 9 and the specific distances 11 can define the region which is passable for the motor vehicle 2. In the undefined portion 12, the edge of the region which can be passed may coincide with the corresponding edge of the travel envelope estimation 9. The travel envelope estimation 9 and the distances 11 or the passable region which is defined thereby are indicated in a state combined in a single data set. This data set can then be provided, for example, for other assistance functions of the motor vehicle 2. To this end, the data set can, for example, be stored in the data store 8 and/or provided or transmitted via the interface 6.

On the whole, the examples described show how an estimation or prediction of a travel envelope can be used in order, based on this, to determine a passable region and relevant boundaries for transverse guiding of a vehicle and to make corresponding data usable in a particularly simple and efficient manner.

### LIST OF REFERENCE NUMERALS

Road
Motor vehicle
Carriageway edge
Environmental sensor system
Assistance system
Interface
Processor
Data store
Travel envelope estimation
Boundary estimation
Distance
Undefined portion
Road lane marking

1-10. (canceled)

11. A method for supporting a longitudinal and transverse guiding of a motor vehicle on a road, the method comprising:
detecting environmental data which characterize a respective environment which is located in front in the travel direction of the motor vehicle;
estimating, based on the environmental data, a path of a boundary which delimits a passable region of the road in the respective environment and a travel envelope which is predicted to be travelled by the motor vehicle;
determining along the travel envelope at least one distance provided transversely relative to the travel direction of the travel envelope from the estimated path of the boundary; and
producing and providing a data set from the travel envelope and the determined distance, wherein the data set indicates the travel envelope and, as a result of the distance, the region which can be travelled along the travel envelope.

12. The method of claim 11, wherein, for the estimation of the boundary and the travel envelope, a plurality of different data types are combined with each other.

13. The method of claim 11, wherein a distinction is made between hard boundaries which must not be passed and soft boundaries which can be passed.

14. The method of claim 13, wherein only the distances of the travel envelope from the next estimated hard boundaries at both sides of the travel envelope and/or only the distances of the travel envelope from the estimated soft boundaries that are furthest away at both sides of the travel envelope are determined and indicated in the data set.

15. The method of claim 13, wherein the carriageway markings are used as soft boundaries.

16. The method of claim 13, wherein structural devices are used as hard boundaries.

17. The method of claim 13, wherein the hard boundaries include physical boundaries, which cannot be passed, and rule-based boundaries, which may not be passed only in accordance with predetermined rules, and wherein, in the data set, separate distances of the travel envelope from physical boundaries and rule-based boundaries are indicated.

18. The method of claim 11, wherein, in a portion along the travel envelope in which no boundary can be estimated, the distance is set to zero.

19. An assistance system for a motor vehicle, comprising:
an interface configured to detect environmental data that characterize an environment which is located in front in the travel direction;
a processor; and
a memory storing instructions that, when executed by the processor, configure the assistance system to carry out the method of claim 11.

20. A motor vehicle, comprising:
an environmental sensor system configured to record environmental data that characterizes a respective environment which is located in front in the travel direction, and
an assistance system, including:
an interface configured to detect environmental data that characterize an environment which is located in front in the travel direction,
a processor, and
a memory storing instructions that, when executed by the processor, configure the assistance system to carry out the method of claim 11.
